(19) United States
(12) Patent Application Publication
(10) Pub. No.: US 2006/0045215 A1
(43) Pub. Date: Mar. 2, 2006

(54) Method and apparatus for frequency correcting a periodic signal

(75) Inventors: Wayne Wiggins Ballantyne, Coconut Creek, FL (US); Roger C. Hathaway, Phoenix, AZ (US); Silvio Luiz Lima Nogueira, Campines (BR); David Hartley Minasi, Fort Lauderdale, FL (US); Carlos Antonio Miranda-Knapp, Miramar, FL (US); Darren V. Weninger, Chandler, AZ (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 10/930,978

(22) Filed: Aug. 31, 2004

(51) Int. Cl. H04L 27/06

(52) U.S. Cl. 375/344

(57) ABSTRACT

A method and apparatus to correct a periodic signal, such as a frequency reference, based upon another frequency reference. A lower accuracy frequency signal generator (104) provides an uncorrected frequency reference signal (122) to a frequency corrector (106). Frequency corrector (106) counts cycles of a frequency reference signal (124), as generated by a higher accuracy reference generator (102) for a time period derived from the uncorrected frequency signal. Based upon the cycles counted, pulses are added or removed from the uncorrected frequency signal (122) to produce a corrected frequency signal (126). A ratio of pulses to be removed from the uncorrected frequency signal (122) is determined from the number of cycles counted and a counter arrangement is provided to automatically remove the required ratio of pulses from the uncorrected frequency signal (122).

### FIELD OF THE INVENTION

The present invention generally relates to the field of electrical time reference circuits and more particularly to electrical frequency reference generating circuits that correct periodic signals based upon a frequency standard.

### BACKGROUND OF THE INVENTION

Many electronic devices, such as cellular phones and PDAs, require a low frequency oscillator circuit that is commonly used to run a Real Time Clock (RTC) logic block and also to drive other circuits during low power modes. Many devices use a 32.768 kHz crystal oscillator for this purpose. Such devices typically include a higher frequency, more accurate reference oscillator that is disabled during these low power modes. While a precise (e.g., +/−50 ppm) frequency reference is generally not needed while operating in a low power mode, precise frequency references are needed for RTC functions, such as alarms or appointment reminders. This has resulted in requiring the RTC clock, and therefore the low frequency oscillator circuit, to have frequency accuracies that are typically on the order of +/−50 ppm to 100 ppm over their specified operating conditions (e.g., over the full range of temperature, aging, voltage, etc.) This has resulted in the common use of a 32.768 kHz crystal oscillator in these devices.

The use of a 32.768 kHz crystal oscillator, however, adds cost, increases circuit board area, and can degrade the reliability of the device incorporating it. These crystals represent a significant cost component for the device. The circuit board area requirement for such an oscillator is also significant, especially given the trend towards smaller overall device size. The crystal element can also incur cracking (and thus failure) when exposed to a drop or severe vibration environment.

Therefore a need exists for a suitably stable low frequency oscillator that addresses the problems with the prior art as discussed above.

### SUMMARY OF THE INVENTION

In accordance with an exemplary embodiment of the present invention, a frequency corrector includes an interface for receiving an uncorrected frequency signal and a signal period comparator that is communicatively coupled to the interface and that determines an error in period of the uncorrected frequency signal relative to a reference signal period. The reference signal period is based upon a reference frequency signal. The frequency corrector further has a pulse count corrector that is communicatively coupled to the interface and the signal period comparator. The pulse count corrector corrects a pulse count of the uncorrected frequency signal by selectively, based upon the error, adding at least one pulse or removing at least one pulse from the uncorrected frequency signal at a rate determined by the ppm error of the raw uncorrected signal.

In accordance with another aspect of the present invention, a method for correcting a frequency of a signal includes accepting an uncorrected frequency signal and determining an error in an uncorrected signal period of the uncorrected frequency signal relative to a reference signal period. The reference signal period is based upon a reference frequency signal. The method further includes correcting a pulse count of the uncorrected frequency signal by selectively performing, on the uncorrected frequency signal based upon the period error from a period comparator, one of adding at least one pulse and removing at least one pulse.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a block diagram of a cellular telephone incorporating an exemplary embodiment of the present invention.

FIG. 2 illustrates a simplified block diagram of a frequency corrector as used by the exemplary embodiment of the present invention.

FIG. 3 illustrates a detailed block diagram for a frequency corrector according to an exemplary embodiment of the present invention.

FIG. 4 illustrates a block diagram of a pulse adjuster as utilized by an exemplary embodiment of the present invention.

FIG. 5 illustrates a top level processing flow diagram for a frequency adjuster processing as performed by an exemplary embodiment of the present invention.

FIG. 6 illustrates a detailed processing flow diagram for a frequency adjustment processing as performed by the exemplary embodiment of the present invention.

### DETAILED DESCRIPTION

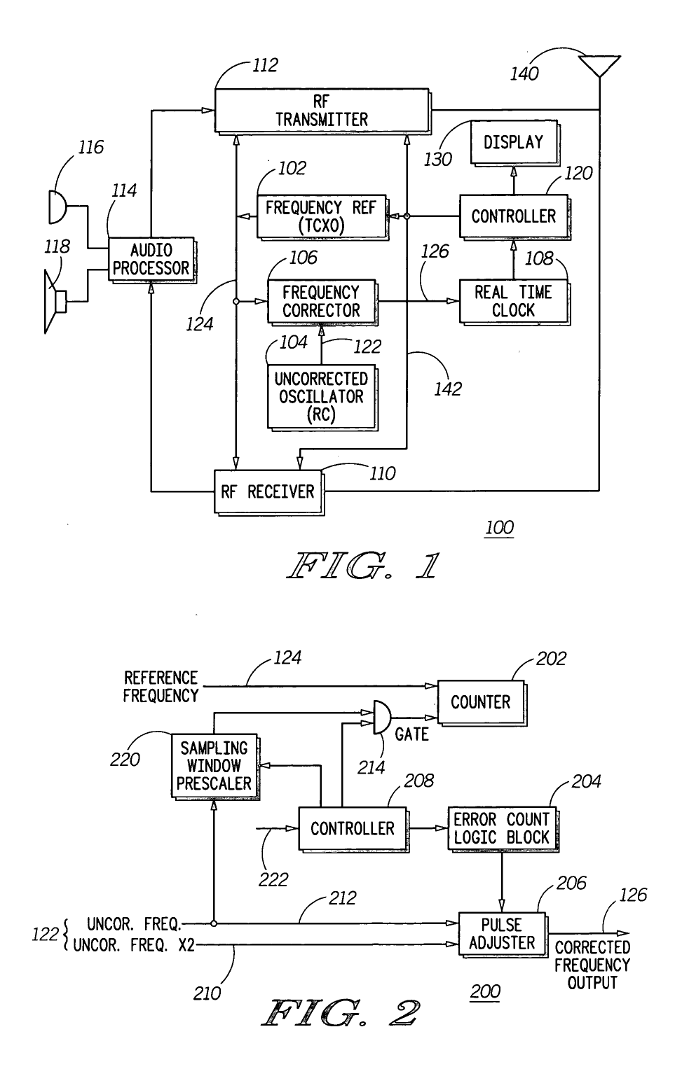

As required, detailed embodiments of the present invention are disclosed herein; however, it is to be understood that the disclosed embodiments are merely exemplary of the invention, which can be embodied in various forms as described in the non-limiting exemplary embodiments of FIGS. 1 through 6. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

FIG. 1 illustrates a block diagram of a cellular telephone 100 incorporating an exemplary embodiment of the present invention. The exemplary cellular telephone 100 operates with advanced mobile wireless communications systems and is designed to minimize power consumption and cost. Wireless communications are performed by the cellular telephone 100 through use of an RF transmitter 112 and an RF receiver 110 that are connected to an antenna 140.

Cellular telephone 100 includes an audio processor 114 that accepts voice signals from a microphone 116, prepares and conditions those signals for transmission from the cellular phone, and delivers those prepared and conditioned signals to the RF transmitter 112. The audio processor 114 further accepts signals from the RF receiver 110, processes those signals to recover audio information and provides audio signal to speaker 118. The RF transmitter 112 and RF receiver 110 further process information and digital data for many purposes, but those are not relevant to the understanding of the present invention.

The cellular telephone 100 of the exemplary embodiment includes time division RF transmitting and receiving modes that only require periodic operation of the RF transmitter 112 and RF receiver 110. Further embodiments of the present invention are incorporated into cellular telephones and other wireless communications devices that operate in Code Division, Multiple Access (CDMA) modes of operation as well as cellular telephones and other wireless communications devices that operate with any type of wireless protocol. In further operating modes, such as a low-power standby, during times within a Time Division Multiplexed (TDM) timeframe not assigned to this cellular phone, or when a user of the cellular phone 100 is not actively communicating, the RF transmitter 112, and sometimes to a lesser extent the RF receiver 110, are placed in a low-power standby mode and do not power up, or remain in a low-power configuration. This type of operation serves to conserve power and extend battery life for portable devices such as cellular phone 100.

RF communications generally require a high degree of frequency accuracy for proper RF signal transmission and reception. The exemplary cellular phone 100 incorporates a frequency reference 102. The frequency reference 102 of the exemplary embodiment is a Temperature Controlled Crystal Oscillator (TCXO) that produces a stable frequency reference at an accurate output frequency. The frequency reference 102 of the exemplary embodiment produces an output frequency at thirty three Megahertz (33 MHz) and is sufficiently accurate, such as +/−3 ppm in the exemplary embodiment, to act as a frequency reference for the RF transmitter 112 and RF receiver 110. Although the frequency reference 102 provides an accurate reference frequency, the operation of such a high stability frequency oscillator 102 requires a relatively large current.

In addition to requiring high frequency stability and accuracy for RF operations, further circuits of the exemplary cellular phone 100 require a stable frequency signal for various operations. For example, a Real Time Clock (RTC) 108 maintains time of day information to support various functions within the exemplary cellular phone 100, such as user set time alarms and a time of day clock displayed on a display panel 130 of the exemplary cellular phone. The Real Time Clock 108 provides time of day and other frequency reference signals to the controller 120 in the exemplary embodiment. Controller 120 further provides control signals 142 to components of the exemplary cellular phone 100. Control signals 142 include, but are not limited to a low power mode command for the frequency reference 102.

Operations of functions such as a Real Time Clock 108 require a constantly available frequency reference signal in order to maintain proper operations. Although the frequency reference 102 is able to provide this frequency reference signal, constant operation of the frequency reference 102 is undesirable due to the high current demand of the frequency reference 102.

In order to conserve power, the exemplary cellular phone 100 only operates the frequency reference 102 when required for operation of either or both of the RF receiver 110 and RF transmitter 112 or for periodic calibration of lower power oscillators when no RF operations are required. When the accurate frequency reference provided by the frequency reference 102 is not required, the frequency reference 102 of the exemplary embodiment is placed into a low-power mode or is powered off and therefore does not produce a reference signal. In order to support the operation of other circuits, for example the Real Time Clock 108 of the exemplary embodiment, another, lower power oscillator, e.g., an uncorrected oscillator 104, is continuously operated and provides another frequency reference signal for those continuously operating circuits. The uncorrected oscillator 104 of the exemplary embodiment is a low power consuming resistor-capacitor (RC) timing circuit based oscillator that operates at a lower frequency than the frequency reference 102 and has an output frequency accuracy on the order of +/−10%. The uncorrected oscillator 104 is designed so as to consume significantly less power than the frequency reference 102. Using the uncorrected oscillator 104 to directly drive the Real Time Clock 108, however, is generally undesirable because the associated frequency error (e.g., 10%) would result in an unacceptable inaccuracy of, for example, an alarm time. For example, for an alarm event scheduled to go off in 10 hours, there could be up to a 1 hour error, which is not acceptable to most users.

In order to provide a suitably stable frequency reference signal to support operations of circuits such as a Real Time Clock, the output of the uncorrected oscillator 104 is corrected by a frequency corrector 106 as described below. The frequency corrector 106 accepts an uncorrected oscillator signal 122 as produced by the uncorrected oscillator 104. The frequency reference output 124, when it is produced by the intermittently operated frequency reference 102, is used by the frequency corrector 106 to determine frequency errors in the output of the uncorrected oscillator 104 and to determine required corrections that are to be applied to the signal received from the uncorrected oscillator output 122 in order to produce a corrected frequency reference signal output 126 suitable for driving, for example, the Real Time Clock 108.

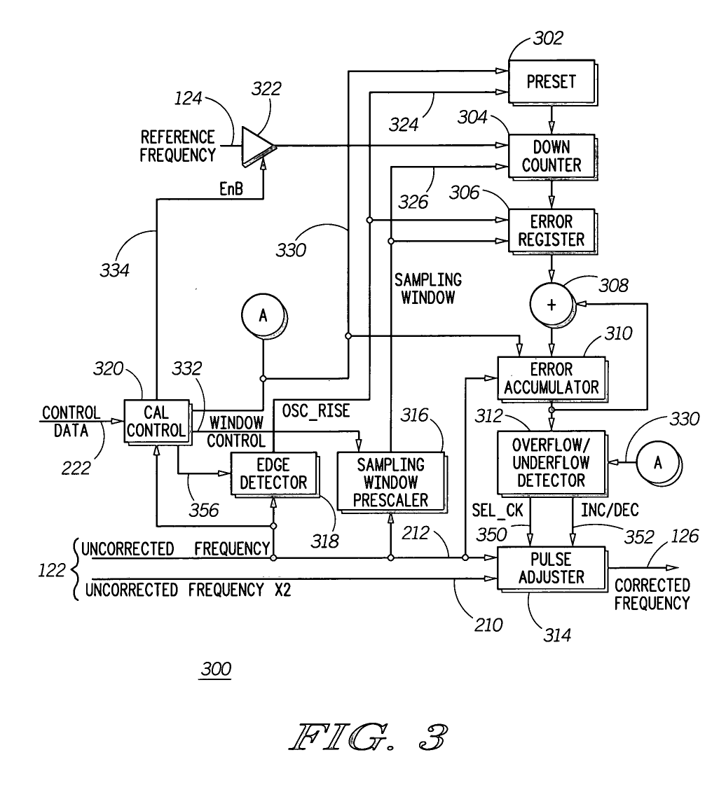

FIG. 2 illustrates a simplified block diagram of a frequency corrector 200 as used by the exemplary embodiment of the present invention. The simplified block diagram of the frequency corrector 200 shows that an uncorrected oscillator output 122 is accepted as an input. The uncorrected oscillator 104 of the exemplary embodiment produces two frequency output signals, an uncorrected frequency signal 212 and an uncorrected frequency X2 signal 210. The uncorrected frequency X2 signal 210 in the exemplary embodiment has a frequency that is substantially twice that of the uncorrected frequency signal 212 and therefore has a higher frequency than the uncorrected frequency signal 212. The uncorrected oscillator 104 of the exemplary embodiment internally generates a higher frequency and produces a 65.536 kHz output signal for use as the uncorrected frequency X2 signal 210 and produces the uncorrected frequency signal 212 at a nominal frequency of 32.768 kHz frequency by frequency dividing that internally generated higher frequency. These signals are subject to a higher degree of frequency uncertainty, such as up to +/−10% frequency inaccuracies for the uncorrected oscillator 104 of the exemplary embodiment, than is acceptable for applications within the cellular phone 100. The frequency corrector 200 has a sampling window prescaler 220 that is used to derive a sampling time window from the uncorrected frequency signal 212. The sampling window prescaler 220 of the exemplary embodiment sets the sampling time window based upon the period of the uncorrected frequency signal 212 by frequency dividing the uncorrected frequency signal 212 by a selected amount, as specified by controller 208 as discussed below. The prescaler of the exemplary embodiment is able to produce sampling window output signals with intervals that are within a range nominally equal to 128 ms to ( 1/512) seconds (which is approximately 2 ms). The interval of the output of the sampling window prescaler 220 varies in proportion to the inaccuracy of the uncorrected frequency signal 212. This variation is measured by the operation of the frequency corrector 200 and is used to determine frequency corrections that are to be applied to the uncorrected frequency signal 212 to produce a corrected frequency signal output 126.

Benefits of the exemplary embodiment of the present invention include the characteristic that the corrected frequency output 126 has a nominal frequency that is substantially close to the nominal frequency of the uncorrected frequency signal 212. In the exemplary embodiment, for example, the uncorrected input frequency signal has a frequency of 32.768 kHz with an accuracy of +/−10% and the corrected frequency output signal has a frequency of 32.768 kHz with an accuracy of +/−50 ppm. This characteristic of the exemplary embodiment of the present invention has significant practical value over conventional systems that produce corrected frequency signals with significantly higher frequency than the uncorrected signal. For example, in such conventional systems when another more accurate version of the original uncorrected frequency signal is desired, these systems are required to divide the frequency of that output signal down to the input frequency, and thereby drawing additional power supply current.

The frequency corrector 200 includes a counter 202, the operation of which is described in more detail below, that is used to count cycles of the reference frequency signal received by the reference frequency signal input 124 during the sampling window interval of the signal generated by the sampling window prescaler 220, which is defined as a multiple of the period of the uncorrected frequency signal 212. The interval period of the output of the prescaler is much longer than the period of the reference frequency signal 124 and therefore many cycles of the reference frequency signal 124 occur during one interval of the output of the sampling window prescaler 220, i.e., during the sample window period.

The uncorrected frequency signal 212 has a desired frequency and a corresponding period, which is the inverse of that frequency. The desired frequency for the uncorrected frequency signal 212 is the frequency at which the corrected frequency signal output 126 is desired to operate. This is also the nominal frequency of the uncorrected frequency signal 212 in the absence of frequency errors or drift introduced by the uncorrected oscillator 104. The operation of the frequency corrector 200 corrects the uncorrected frequency signal 212 so as to have an average frequency that is sufficiently close to this desired frequency to support operation of the exemplary cellular phone 100. The exemplary cellular phone 100 operates with a corrected frequency signal output 126 that has an exemplary frequency accuracy of +/−50 ppm.

The counter 202 provides a count value of cycles of the reference signal 124 that are counted during the sampling window interval. This count is compared to an expected number of cycles of the reference frequency signal 124 that would have been counted if no correction were required, i.e., if the uncorrected frequency signal 212 were at its desired frequency. This count by the counter 202, which is referred to as an error count herein, is received by the error count logic block 204. The error count logic block 204 of the exemplary embodiment conditions the error count data. The error count logic block 204 then produces control instructions to control a pulse adjuster 206 in response to observed error counts. The pulse adjuster 206, in response to these control instructions, iteratively inserts pulses into or removes pulses from the uncorrected frequency signal 122 as required to correct the uncorrected frequency signal.

Controller 208 operates to control the counting of the reference frequency by enabling the output of the sampling window prescaler 220 to be fed to the gate of counter 202 by AND gate 214. The controller 208 further controls the sampling window prescaler 220 to control the sampling window interval over which counter 202 will count cycles of the reference frequency signal 124. The controller 208 accepts control information 222 to control the operation of the frequency corrector 200. Control information 222 is received in the exemplary embodiment from the cellular telephone controller 120.

FIG. 3 illustrates a detailed block diagram for a frequency corrector 300 according to an exemplary embodiment of the present invention. The detailed block diagram for the frequency corrector 300 has a Calibration Controller 320 that controls the operation of the frequency corrector 300. Calibration Controller 320 accepts control information 222 that controls the operation of the frequency corrector 300. The Calibration Controller 320 is configured, via control information 222, with the number of reference frequency cycles, as received from the reference frequency input 124, that are expected to be counted during a sampling window interval that is derived from the uncorrected frequency signal 212. This expected count value is, in turn, provided to a preset register 302 via a preset register value interface 330.

The Calibration Controller 320 receives the uncorrected frequency signal 212 and operates several timing circuits based on that frequency signal. The calibration controller, for example, operates a 2 ms interval timer that wakes-up the reference TCXO oscillator 102 prior to the sampling window to allow the output of the reference oscillator 102 to stabilize. The calibration controller of the exemplary embodiment further supports a periodic calibration mode in which a programmable calibration period timer (generally with a time duration of 16 seconds and up) is maintained.

As explained above, the uncorrected oscillator signal 122 includes an uncorrected frequency signal 212 and an uncorrected frequency X2 signal 210. The uncorrected frequency signal 212 is provided to an edge detector 318 that produces an Osc_Rise signal 324, which is a conditioned, digital data signal level that corresponds to a positive going transition of the uncorrected frequency signal 212. The uncorrected frequency X2 signal 210 is a second frequency signal that has a frequency that is substantially twice that of the uncorrected frequency signal. The uncorrected frequency signal 212 and the uncorrected frequency X2 signal 210 are provided by the uncorrected oscillator 104, which is an uncorrected RC oscillator in the exemplary embodiment. The uncorrected frequency signal 212 and the second frequency signal, i.e., the uncorrected frequency X2 signal 210, that are generated by the uncorrected oscillator 104 in the exemplary embodiment are accepted by various circuits as illustrated in the detailed block diagram for the frequency corrector 300. Embodiments of the present invention have uncorrected frequency signal sources that are signal input connections to external signals generated by various signal generators. The uncorrected frequency source of the exemplary embodiment, i.e., the uncorrected RC oscillator 104, is a low power consuming oscillator that exhibits very low power consumption during operation.

The uncorrected frequency signal 212 also drives a sampling window prescaler 316. Sampling window prescaler 316 produces a sampling window signal 326 that is an enable signal with an interval that corresponds to a sample window interval, which is the time interval during which the uncorrected frequency signal 212 is compared to the reference frequency 124. The time duration period of the sampling window signal 326, which is the sample window interval in the exemplary embodiment, is based upon the period of the uncorrected frequency signal 212 and is typically an integer multiple of the period of the uncorrected frequency signal 212.

An exemplary embodiment of the present invention incorporates a sampling window prescaler 316 that includes a down counter for the uncorrected frequency signal 212. The calibration controller 320 provides a preset value to the down counter in the sampling window prescaler 316 which is separate, but related to, the preset value provided to Preset register 302. These separate values result from the configuration of the exemplary embodiment in which the down counter 304 counts cycles of the reference frequency 124, which is 33 MHz, while the sampling window prescaler 316 counts cycles of the uncorrected frequency signal 212, which is nominally 32 kHz.

In the operation of this exemplary embodiment, the sampling window prescaler 316 is loaded, or preset, with the number of 32 kHz periods that corresponds to the Np number of reference frequency signal periods that are expected to be counted in the desired sampling window time. Longer sampling window times can be selected to allow for higher resolution in measuring the frequency error.

Further embodiments of the present invention are able to incorporate a sampling window prescaler 316 that has seven (7) prescalers that operate in series and divide the frequency of the uncorrected frequency signal 212 so as to produce a sampling window signal 326 that has one of eight frequencies (with corresponding cycle durations). The desired prescaler output in these embodiments is in turn selected by the window control signal 332 that is produced by the Calibration Controller 320 and that drives an 8-to-1 multiplexer within the sampling window prescaler 316. This 8-to-1 multiplexer has one input connected to each output of the prescaler. The sampling window signal 326 is selected from the seven outputs of the prescaler that are logically asserted for time intervals that correspond to the inverse of frequencies nominally equal to 8 Hz, 16 Hz, 32 Hz, 64 Hz, 128 Hz, 256 Hz and 512 Hz. The sampling window signal 326 deviates from the selected nominal frequency due to the inaccuracy of the uncorrected frequency signal 212 from which it is derived and based. The sampling window 326 is provided to the down counter 304 and the error register 306 for use as described below.

The reference frequency signal 124, which is a highly stable frequency standard generated by a signal generator that is the temperature controlled crystal reference frequency oscillator 102 in the exemplary embodiment, is received by a buffer 322. Buffer 322 receives an EnB signal 334 from the Calibration Controller 320 to allow the buffered output of buffer 322 to drive the Down Counter 304. The down counter 304 uses the buffered output of buffer 322 for measuring errors in the frequency of the uncorrected frequency signal 212 as described below.

The operation of the exemplary frequency corrector 300 begins by the Calibration Controller 320 loading the expected number of reference frequency clock cycles, referred to herein as Np, into the preset register 302. This expected number of reference frequency clock cycles to be counted during the calibration window pulse generated by the sampling window prescaler 316 is received by the Calibration Controller 320 in the exemplary embodiment over the control data interface 122 and is provided along the preset interface 330. Further embodiments of the present invention provide the value of Np through various methods, such as calculating this value based upon the calibration window interval or via values that are stored within the Calibration Controller 320. The Osc_Rise signal 324, as produced by edge detector 318, causes the latching of this predetermined value of Np into the preset register 302 to be synchronized with the phase of the uncorrected frequency signal 212. The preset register then loads this predetermined preset count value to the down counter 304 before the start of the sample window interval.

The exemplary embodiment of the present invention counts the number of cycles of the reference frequency signal 124 during the sampling window interval. In this description, the sampling window interval is the interval during which the sampling window signal 326 is asserted. Before the start of the sampling window, the Calibration Controller 320 of the exemplary embodiment enables the frequency reference 102 to generate the reference frequency signal. In the exemplary embodiment, the frequency reference 102 is powered up prior to the start of the sample window interval. Various embodiments of the present invention start the operation of the frequency reference 102 at various times prior to the beginning of the calibration window in order to allow the frequency reference 102 to stabilize.

Some embodiments of the present invention operate the down counter 304, reference frequency 124, buffer 322, and other associated circuitry on an intermittent basis. In these embodiments, the reference frequency signal 124 is only intermittently produced by the reference frequency oscillator 102. A Calibration Controller 320 of these embodiments causes the down counter and associated circuits to operate on a periodic basis with a period specified by an external controller through control data 122. These embodiments enable the operation of a signal generator, such as frequency reference generator 102, as required for the intermittent operation of the signal period comparator, which includes the down counter 304 and associated circuits in the exemplary embodiment. This results in enabling the frequency reference generator 102 upon intermittent performance of determining an error ratio of the uncorrected frequency signal 212 and the reference frequency 124, as described in detail below.

Down counter 304 accepts the sampling window signal 326 that is produced by the sampling window prescaler 316. Upon the assertion of the sampling window signal 326, the preset value is loaded into a register of the down counter 304 and down counting is enabled. While down counting is enabled, the value stored in the register of down counter 304 decrements by one upon each cycle of the reference frequency signal 124 that is also provided to the down counter 304. The instantaneous value in this down counter register reflects Np minus the number of cycles of the reference frequency signal 124 that have occurred during the sampling window interval. In the exemplary embodiment, the reference frequency signal 124 has a much shorter period than the interval of the sampling window signal 326, which has a frequency between 512 Hz and 8 Hz in the exemplary embodiment, and therefore many clock cycles of the reference frequency signal 124 occur during one cycle of the sampling window signal 326.

The value loaded into the preset register 302 and loaded into the register of the down counter 304 at the beginning of the cycle sampling window signal 326 is selected in the exemplary embodiment so that the value of the down counter 304 would be zero at the end of the sample window interval if there were no frequency error in the uncorrected frequency signal 212. Any errors in the uncorrected frequency signal 212, however, result in the register of the down counter 304 having a final value, which is the value stored in the down counter 304 at the end of the sample window interval, that is not equal to zero. This final value corresponds to an error in the uncorrected period (i.e., the period of the uncorrected frequency signal 212) relative to a reference signal period, which is the period of each cycle of the reference frequency signal 124 in the exemplary embodiment. In obtaining this final value, the exemplary embodiment determines this error amount and suitably applies this error to correct the uncorrected frequency signal 212, as described below.

This final value, which is the value that is stored in the down counter 304 at the end of the sample window interval, is able to have a value that is greater than, equal to or less than zero. The register of the down counter 304 contains final values less than zero when the down counter 304 counts more cycles than the predetermined value that was initially loaded into the down counter 304. This occurs when the uncorrected period is too long, thereby elongating the sample window interval. The down counter 304 of the exemplary embodiment is designed to handle such negative count numbers and predictably provide a representative output for this negative number.

Error register 306 latches the final value, i.e., the value stored in the register of the down counter 304 at the end of the sample window interval. The error register 306 is synchronized to the falling edge of the sampling window signal 326. The sampling window signal 326 in this exemplary embodiment indicates the exact time duration of the sampling window. The sampling window time duration is an integer number of periods of the uncorrected frequency 212 in order to support precise error measurement. The error register of the exemplary embodiment contains a number equal to the number of reference cycle counts that were counted or not counted during an error in the sampling window interval relative to a sample window interval that would correspond to no frequency error being present in the uncorrected frequency signal 212. The count in the error register 306 therefore indicates the magnitude, as well as the sign, of the timing error of the uncorrected frequency signal 212. Osc_Rise 324 is provided to error register 306 in order to cause initialization of the error register at the beginning of each calibration cycle. A Pre_Cal_Init signal 356, which is asserted just before the calibration process begins, is provided to the edge detector 318 to allow the edge detector 318 to output a single rising edge just before the calibration period begins. This causes the assertion of the sampling window signal 326 after the initialization values contained in the preset register 302 and the error register 306 have already been latched.

As can be derived from the above description and the detailed block diagram for the frequency corrector 300, the value latched into error register 306 divided by the expected number of reference frequency cycles, Np, corresponds to the frequency error ratio, which is similar to a parts-per-million (ppm) error, for the uncorrected frequency signal 212. This error ratio also corresponds to the ratio of additional or missing cycles that are actually present in the uncorrected frequency signal 212 relative to the number of cycles that would be present if the uncorrected frequency signal had no frequency errors. This relationship can be expressed by the following equation.
[Value in Error Reg. 306]/Np=[% error in Uncorr. Freq. Sig. 212]/100

The operation of the exemplary embodiment of the present invention inserts or removes, according to the sign of the value in the error register 306, pulses to or from the uncorrected frequency signal 212 in a proportion equal to the ratio between the value in error register 306 and Np. The exemplary embodiment performs this processing as described below.

Adder 308 and error accumulator 310 in the exemplary embodiment operate continuously to determine when to add or remove a correcting pulse to or from the uncorrected frequency signal 212. The operation of these functions continues both during and after sampling windows controlled by the sampling window signal 326. The error accumulator 310 accepts the uncorrected frequency signal 212 as a latch input that causes the error accumulator 310 to latch a new value from its input during each cycle of the uncorrected frequency signal 212. Due to the accumulating structure formed by adder 308, error register 306, and error accumulator 310, the value stored in the error accumulator 310 is incremented during each cycle of the uncorrected frequency signal 212 by the final value that is contained in the error register 306.

The error accumulator 310 accumulates this sum until the magnitude of the value stored in error accumulator 310 reaches or exceeds a predetermined rollover value, which is set in the exemplary embodiment to the Np number of reference frequency clock cycles that are expected during the sample window interval. This predetermined rollover value is equal to Np as provided by preset interface 330. This count magnitude in the exemplary embodiment is equal to the initial count provided to the preset register 302 and loaded into the down counter 304. The error accumulator 310 of the exemplary embodiment is then configured to determine when a magnitude of the value contained in the error accumulator register crosses this predetermined rollover value. The crossing of this predetermined rollover value is indicated by an overflow or underflow of the register when this count is reached in the exemplary embodiment.

The overflow/underflow detector 312 determines when this underflow or overflow condition is reached. In response to determining that the magnitude of the value of the error accumulator register 310 crossed the predetermined rollover value, the pulse adjuster 314 corrects the uncorrected frequency signal 212 by either adding or removing at least one pulse. The exemplary embodiment of the present invention compares the value of the error accumulator register 310 to the preset interface 330, as produced by the Calibration Controller 320 and delivered to the overflow/underflow detector 312. If the error accumulator 310 is determined to have overflowed, i.e., the error accumulator value was greater than Np, the uncorrected frequency signal 212 is to be corrected by having a pulse removed. If the error accumulator 310 has underflowed, i.e., its magnitude exceeds Np but its sign is negative, the uncorrected frequency signal 212 is to be corrected by having a pulse inserted. The overflow/underflow detector 312 produces a Sel_Ck signal 350 and an Increment/Decrement (Inc/Dec) signal 352 to appropriately control the operation of the pulse adjuster 314 based upon an observed overflow or underflow condition for the error accumulator 310. As discussed above, the frequency of this overflow/underflow condition occurs at a rate that is in proportion to the frequency error of the uncorrected frequency signal 212 as determined during the calibration window, discussed above.

Pulse adjuster 314 of the exemplary embodiment accepts the uncorrected frequency signal 212 and the uncorrected frequency X2 signal 210 and produces a corrected frequency signal 126. The pulse adjuster 314 of the exemplary embodiment corrects the pulse count of the uncorrected frequency signal 212 by selectively adding or removing, one pulse from the pulse train delivered on the uncorrected frequency signal 212. The adding or removing of a pulse by the pulse adjuster 314 is controlled by the control values of Sel_Ck signal 350 and Inc/Dec signal 352 produced by the overflow/underflow detector 312 based upon detection of an overflow or underflow of the error accumulator 310. This results in the adding or removing of a pulse based upon the error in the uncorrected signal period, as determined above.

The pulse adjuster 314 adds pulses when required by temporarily selecting the uncorrected frequency X2 signal 210 for output as the corrected frequency. The operation of the exemplary embodiment selects the uncorrected frequency X2 signal 210 for output for two cycles of the uncorrected frequency X2 signal 210, which corresponds to one cycle of the uncorrected frequency signal 212. This operation serves to add one pulse by replacing one pulse of the uncorrected frequency signal 212 with two pulses from the second frequency signal, i.e., the uncorrected frequency X2 signal 210. This causes the frequency of the corrected frequency signal to double for that period. Although this results in an apparent short term frequency instability in this exemplary embodiment, the frequency of the corrected frequency signal 126 of the exemplary embodiment is divided several times by follow-on circuits (not shown) to produce a low frequency timing signal suitable to drive, for example, a Real Time Clock. Therefore, in this exemplary embodiment, this apparent short term frequency instability of the corrected frequency output is acceptable. Removing of a pulse is accomplished by a one time removal of a pulse from the pulse stream. This likewise produces a short term frequency inaccuracy, but is acceptable for the purposes of the exemplary embodiment.

The exemplary embodiment, as described herein, operates by loading a predetermined value into the down counter 304 prior to the start of the sample window interval. Further embodiments of the present invention utilize an up counter that starts with a value of zero or other predefined value and counts up. Such embodiments have a final value stored in the up counter that is related to the error in the uncorrected frequency signal 212 and can be appropriately processed to determine an error in the uncorrected signal period of the uncorrected frequency signal 212 relative to a reference signal period.

The exemplary embodiment, as described herein, operates by using an error accumulator that accumulates a value by adding the final value stored in the error register 306 to the value in the accumulator during each cycle of the uncorrected frequency signal 212 and monitors this accumulated value to determine when its magnitude equals or exceeds Np. Further embodiments of the present invention utilize error accumulators that similarly accumulate a count, but the accumulator does not add a value during each cycle of the uncorrected frequency signal. Some of these embodiments decrease the magnitude of the value stored in the error accumulator at a rate equal to the final value stored in the error register for each period of the uncorrected frequency signal 212. Further embodiments scale the operation of the error accumulator to achieve similar results. All of these embodiments modify the error accumulator register by being one of incremented and decremented by the final value during cycle periods of the uncorrected frequency signal 212. These embodiments determine the period at which to add or remove at least one pulse from the uncorrected frequency signal by determining when the error accumulator register crosses a predetermined rollover value, such as when the count of the error accumulator register reaches a value of zero, reaches a predefined count value, reaches a predefined count value based upon a scaled number of counts, and so forth. For example, an alternative embodiment of the present invention is able to increment the error accumulator register by the final value from an initial value of zero and add or remove two pulses from the uncorrected frequency signal 212 when the count of the error accumulator register reaches a predefined rollover value that is defined to be twice the value of Np. In such a case, reaching or exceeding twice the value of Np constitutes crossing that predetermined rollover value. These and many other variations are within the scope of the present invention.

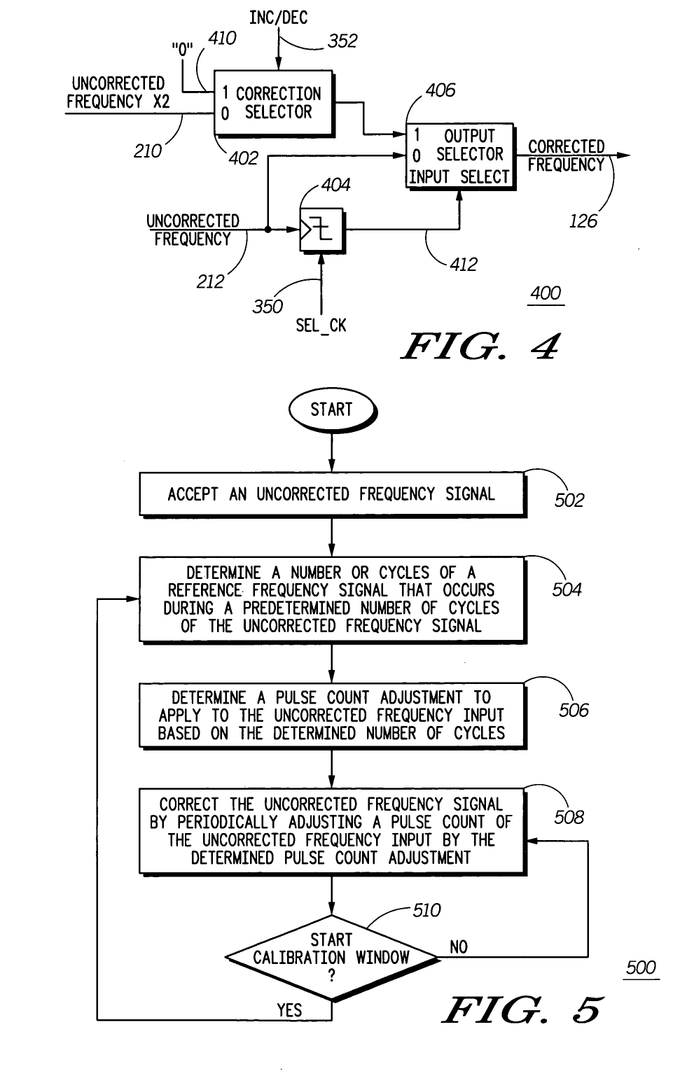

FIG. 4 illustrates a pulse adjuster block diagram 400 that corresponds to a pulse adjuster 314 as used within the exemplary embodiment of the present invention. As illustrated above, the pulse adjuster 314 accepts the uncorrected frequency signal 212 and the uncorrected frequency X2 signal 210 as inputs. The pulse adjuster further accepts a Sel_Ck signal 350 and the Inc/Dec signal 352 as generated by the overflow/underflow detector 312, as discussed above.

The pulse adjuster 314 includes a correction selector 402 that is used to select a correction signal that is able to be either a “zero” (“0”) input 410 or the uncorrected frequency X2 signal 210. The first selector 402 selects between these two inputs based upon the value of the Inc/Dec signal 352. If the uncorrected frequency signal 212 has a frequency that is too high, the first selector 402 selects the “zero” value 410 to essentially remove a pulse from the corrected frequency output 126, as described below. If the uncorrected frequency signal 212 has a frequency that is too low, the first selector 402 selects the uncorrected frequency X2 signal 210 to essentially add a pulse to the corrected frequency output 126, as also described below.

Output selector 406 selects an input for use as the corrected frequency output 126 from between the uncorrected frequency signal 212 and the output of the first selector 402. The output selector is controlled by a negative edge triggered D-type flip-flop 404 that synchronizes the Sel_Ck signal 350 to falling edges of the uncorrected frequency signal 212 in order to avoid glitches or false edges in the corrected frequency output 126. The Sel_Ck signal 350 is asserted by the overflow/underflow detector 312 at a rate that corresponds to corrections that are required to be applied to the uncorrected frequency signal 212. The negative edge triggered D-type flip-flop 404 also receives the uncorrected frequency signal 212 and asserts a correction latch signal 412 for one period of the uncorrected frequency signal 212 when triggered by the Sel_Ck signal 350. The output selector 406 selects the uncorrected frequency signal 212 when the correction latch signal 412, which is received at an input select input port, is not asserted. The output selector selects the output of the first selector 402 when the correction latch signal 412 is asserted. If the frequency of the uncorrected frequency signal 212 is too high, the Inc/Dec signal 352 is asserted and the “zero” input 410 is selected during assertion of the correction latch signal 412, thereby removing one pulse from the corrected frequency output 126. If the frequency of the uncorrected frequency signal 212 is too low, the Inc/Dec signal 352 is de-asserted and the uncorrected frequency X2 signal 210 is selected during assertion of the correction latch signal 412. Since the selection latch signal is asserted for one period of the uncorrected frequency signal 212, this results in two cycles of the uncorrected frequency X2 signal 210 being inserted into the corrected frequency signal 126, thereby adding one pulse to the corrected frequency output 126 and correcting for the lower frequency of the uncorrected frequency signal 212.

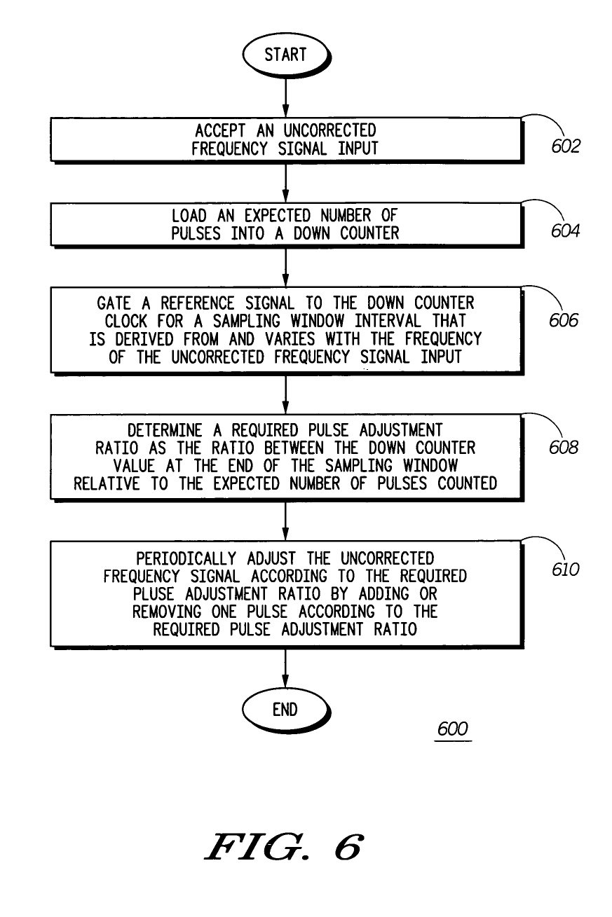

FIG. 5 illustrates a top level processing flow diagram 500 for a frequency adjuster processing as performed by an exemplary embodiment of the present invention. The top level processing flow diagram 500 begins by accepting, at step 502, an uncorrected frequency signal, such as uncorrected oscillator signal 122. The processing of the exemplary embodiment then determines, at step 504, a number of cycles of an accurate frequency reference signal, such as reference frequency signal 124, that occur during a predetermined number of cycles of the uncorrected frequency input. Based upon this determined number of cycles, the processing then determines, at step 506, a pulse count adjustment that is to be applied to the uncorrected frequency signal in order to correct determined frequency inaccuracies in that signal. The processing then corrects, at step 508, the uncorrected frequency signal by periodically adjusting the pulse rate of the uncorrected frequency signal according to the previously determined adjustment. The processing of the exemplary embodiment is able to be configured to perform the above steps as a “one shot” process or to periodically perform the steps of determining a number of cycles and determining a pulse count adjustment in order to autonomously support continuous operation. Some embodiments of the present invention only activate a generator of the reference frequency signal, e.g., the frequency reference 102, during the step of determining a number of cycles, step 504, and deactivate the frequency reference signal at other times to conserve electrical energy. The processing then determines, at step 510, if a new calibration window is to be started. A new calibration window may be started in response to the receipt of a “one shot” command by the calibration controller 320 or after expiration of a configured time interval if calibration is to be automatically repeated. If new calibration window is to be started, the processing returns to determining, at step 504, a number of cycles of a reference frequency signal that occurring during a predetermined number of cycles of the uncorrected frequency signal. If a new calibration window is not to be started, the processing returns to correcting, at step 508, the uncorrected frequency signal, as described above.

FIG. 6 illustrates a detailed processing flow diagram for a frequency adjustment processing 600 as performed by the exemplary embodiment of the present invention. The detailed frequency adjustment processing flow 600 begins by accepting, at step 602, an uncorrected frequency input. The processing then proceeds by loading, at step 604, an expected number of pulses of a reference frequency signal, such as reference frequency signal 124, into a down counter circuit. The processing then gates, at step 606, the reference frequency signal to the down-count clock input of the down counter circuit for a sampling time window. The sampling time window in the exemplary embodiment is determined by a gating pulse that is generated by frequency dividing the uncorrected frequency signal by a predetermined amount, such as by a prescaler. The processing then determines, at step 608, a pulse adjustment ratio as a ratio of the count that is contained in the down counter at the end of the sampling window and the initial count of the down counter that was loaded at the beginning of the sampling window. The processing then proceeds to periodically adjust, at step 610, the uncorrected frequency signal according to the determined pulse adjustment ratio by adding or removing one pulse according to the pulse adjustment ratio.

The exemplary embodiments of the present invention advantageously allow a lower power, lower cost, but lower accuracy frequency reference oscillator to be used as a continuous frequency reference source while a higher power consuming, but higher accuracy, frequency reference is only intermittently activated to measure frequency errors in the lower power reference. The operation of the exemplary embodiments continuously correct the output of the lower accuracy reference oscillator to realize improved frequency accuracy for a corrected frequency signal produced by the exemplary embodiments. The exemplary embodiments further allow a frequency reference source oscillator to be used that has a nominal frequency that is substantially equal to the desired output reference frequency signal without the attendant circuit complexity and power consumption of employing a fractional-N frequency synthesizer.

The exemplary embodiments of the present invention advantageously allow periodic and/or intermittent correction of the lower power, lower cost, but lower accuracy frequency reference oscillator while other components within the cellular phone, or other device incorporating an embodiment of the present invention, are otherwise powered off. The exemplary embodiments can be configured to activate the frequency reference 102 during intermittent intervals when corrections to be applied to the output of the uncorrected oscillator 104 are being determined. This is particularly advantageous in applications, such as certain cellular phone applications, when a Real Time Clock is required to be maintained when no RF operations are being performed, such as when the cellular phone is in standby mode or powered down (i.e., “off”). Such cellular phones are further optimized by reducing power consumption because the uncorrected oscillator and the frequency corrector are not operating when performing RF operations if time of day information can be received from a base station communicating with the particular cellular phone or device incorporating the particular embodiment.

Further advantages of the exemplary embodiments of the present invention include an ability to initiate and apply frequency corrections without software intervention and an ability to initiate and maintain the correction process automatically, even when the cell phone or device is essentially off. Automatic correction is maintained, for example, by only powering up the reference frequency 124 intermittently.

The present invention can be realized in hardware, software, or a combination of hardware and software. A system according to an exemplary embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a machine readable medium containing a definition of a machine executable method, which comprises all the features enabling the implementation of the methods described herein, and which, when loaded in a suitable machine, is able to carry out these methods. Machine readable medium and machine executable method in the present context means any expression, in any language, code or notation, of a set of instructions intended to cause a system having an information processing capability to perform a particular function either directly or after either or both of the following a) conversion to another language, code or, notation; and b) reproduction in a different material form.

Such suitable machines may include Field Programmable Gate Arrays (FPGAs), Programmable Logic Devices (PLDs), and the like. The machine readable medium may include non-volatile memory, such as ROM, Flash memory, disk drive memory, CD-ROM, and other permanent storage. Additionally, a machine readable medium may include, for example, volatile storage such as RAM, buffers, cache memory, and network circuits. Furthermore, the machine readable medium may comprise machine readable information in a transitory state medium such as a network link and/or a network interface, including a wired network or a wireless network, that allow a computer to read such computer readable information.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The terms “between” and “among” are not to be interpreted as limiting, the use of “between” alone is not to be interpreted as a term of limitation that restricts an action to only two objects, and the use of “among” alone is not to be interpreted as a term of limitation that excludes an action from operating upon only two objects.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A frequency corrector comprising:
an interface for receiving an uncorrected frequency signal;
a signal period comparator communicatively coupled to the interface, the signal period comparator determining an error in period of the uncorrected frequency signal relative to a reference signal period, the reference signal period based upon a reference frequency signal; and
a pulse count corrector communicatively coupled to the interface and the signal period comparator, the pulse count corrector correcting a pulse count of the uncorrected frequency signal by selectively, based upon the error, adding at least one pulse or removing at least one pulse from the uncorrected frequency signal.

2. The frequency corrector according to claim 1, further comprising an oscillator coupled to the interface, the oscillator providing the uncorrected frequency signal and having a frequency accuracy less than the reference frequency signal.

3. The frequency corrector according to claim 1, wherein the signal period comparator comprises a counter that counts cycles of the reference frequency signal for a sample window interval, wherein the counter is loaded with a pre-determined value before a start of the sample window interval, the error is determined based upon a final value that is stored in the counter at the end of the sample window interval, and the sample window interval is based upon a period of the uncorrected frequency signal.

4. The frequency corrector according to claim 3, wherein the pulse count corrector comprises an error accumulator that comprises an error accumulator register, the error accumulator register being one of incremented and decremented by the final value during cycle periods of the uncorrected frequency signal, the at least one of adding at least one pulse and removing at least one pulse being performed in response to a determination that a magnitude of the value of the error accumulator register crosses a pre-determined rollover value.

5. The frequency corrector according to claim 3, wherein the interface further receives a second frequency signal with a second frequency that is substantially twice that of the uncorrected frequency signal, and the pulse count corrector performs adding at least one pulse by replacing at least one pulse of the uncorrected frequency signal with pulses from the second frequency signal.

6. The frequency corrector according to claim 3, wherein the signal period comparator automatically operates on an intermittent basis.

7. The frequency corrector according to claim 6, wherein the signal period comparator enables a signal generator that generates the reference frequency signal upon intermittent operation of the signal period comparator.

8. A method for correcting a frequency of a signal, the method comprising the steps of:
accepting an uncorrected frequency signal;
determining an error in an uncorrected signal period of the uncorrected frequency signal relative to a reference signal period, the reference signal period based upon a reference frequency signal; and
correcting a pulse count of the uncorrected frequency signal by selectively performing on the uncorrected frequency signal, based upon the error, one of adding at least one pulse and removing at least one pulse.

9. The method according to claim 8, further comprising the step of generating the uncorrected frequency signal with a frequency accuracy less than the reference frequency signal.

10. The method according to claim 8, wherein the determining step comprises counting cycles of the reference frequency signal for a sample window interval, the sample window interval being based upon a period of the uncorrected frequency signal, the counting comprising:
loading a counter with a pre-determined value before a start of the sample window interval; and
determining the error based upon a final value that is stored in the counter at the end of the sample window interval.

11. The method according to claim 10, wherein the correcting step comprises one of incrementing and decrementing an error accumulator register by the final value during cycle periods of the uncorrected frequency signal, the at least one of adding at least one pulse and removing at least one pulse being performed in response to a determination that a magnitude of the value of the error accumulator register crosses a pre-determined rollover value.

12. The method according to claim 10, further comprising the step of accepting a second frequency signal with a second frequency that is substantially twice that of the uncorrected frequency signal, and the adding at least one pulse comprises replacing at least one pulse of the uncorrected frequency signal with pulses from the second frequency signal.

13. The method according to claim 10, wherein the determining step is automatically performed on an intermittent basis.

14. The method according to claim 13, wherein the determining step further comprises enabling a signal generator that generates the reference frequency signal upon intermittent performance of the determining an error.

15. A machine readable medium containing a definition of a machine executable method for correcting a frequency of a signal, the machine executable method comprising the steps of:
accepting an uncorrected frequency signal;
determining an error in an uncorrected signal period of the uncorrected frequency signal relative to a reference signal period, the reference signal period based upon the reference frequency signal; and
correcting a pulse count of the uncorrected frequency signal by selectively performing on the uncorrected frequency signal, based upon the error, one of adding at least one pulse and removing at least one pulse.

16. The machine readable medium according to claim 15, wherein the determining step comprises counting cycles of the reference frequency signal for a sample window interval, the sample window interval being based upon a period of the uncorrected frequency signal, the counting comprising:
loading a counter with a pre-determined value before a start of the sample window interval; and
determining the error based upon a final value that is stored in the counter at the end of the sample window interval.

17. The machine readable medium according to claim 15, wherein the correcting step comprises one of incremented and decremented an error accumulator register by the final value during cycle periods of the uncorrected frequency signal, the at least one of adding at least one pulse and removing at least one pulse being performed in response to a determination that a magnitude of the value of the error accumulator register crosses a predetermined rollover value.

18. The machine readable medium according to claim 15,
wherein the machine executable method further comprises the step of accepting a second frequency signal with a second frequency that is substantially twice that of the uncorrected frequency signal, and
the adding step comprises replacing at least one pulse of the uncorrected frequency signal with pulses from the second frequency signal.

19. The machine readable medium according to claim 15, wherein the determining step is automatically performed on an intermittent basis.

20. An electronic device comprising:
a circuit accepting a corrected frequency signal;
an uncorrected frequency signal source providing an uncorrected frequency signal;
a signal period comparator communicatively coupled to the uncorrected frequency signal source, the signal period comparator determining an error in an uncorrected signal period of the uncorrected frequency signal relative to a reference signal period, the reference signal period based upon the reference frequency signal; and
a pulse count corrector communicatively coupled to the uncorrected frequency signal source and the signal period comparator, the pulse count corrector correcting a pulse count of the uncorrected frequency signal by selectively performing on the uncorrected frequency signal, based upon the error, one of adding at least one pulse and removing at least one pulse.
